(19) United States
(12) Patent Application Publication
(10) Pub. No.: US 2023/0245103 A1
(43) Pub. Date: Aug. 3, 2023

(54) SYSTEM AND METHOD OF DISPLAYING AND ON-DEMAND MINTING OF NFTS ACROSS MULTIPLE BLOCKCHAINS

(71) Applicant: Luut Technologies, Inc., Toronto (CA)

(72) Inventor: Catherine LACAVERA, Toronto (CA)

(21) Appl. No.: 18/162,460

(22) Filed: Jan. 31, 2023

Related U.S. Application Data
(60) Provisional application No. 63/305,547, filed on Feb. 1, 2022.

(51) Int. Cl. G06Q 20/36; H04L 9/32; H04L 9/30; H04L 9/14; H04L 9/00

(52) U.S. Cl. CPC G06Q 20/3672; H04L 9/3213; H04L 9/30; H04L 9/14; H04L 9/50; G06Q 2220/00; H04L 2209/60

(57) ABSTRACT

An apparatus has a processor and a network interface circuit connected to the processor to provide connectivity to networked machines. A memory is connected to the processor. The memory stores instructions executed by the processor to establish a first network connection to a first proprietary block chain to obtain first non-fungible token (NFT) attributes associated with a first public key. A second network connection is created to a second proprietary block chain to obtain second NFT attributes associated with a second public key. A third network connection with a client machine supplies the first NFT attributes and the second NFT attributes.

### CROSS-REFERENCE TO RELATED APPLICATION

This application claims priority to U.S. Provisional Patent Application No. 63/305,547, filed Feb. 1, 2022, the contents of which are incorporated herein by reference.

### FIELD OF THE INVENTION

This invention relates generally to digital non-fungible tokens (NFTs). More particularly, this invention is directed to techniques for displaying and on-demand minting of NFTs across multiple blockchains.

### BACKGROUND OF THE INVENTION

There is a proliferation of blockchains and of crypto wallets typically supporting only one or two blockchains. NFT enthusiasts frequently need many different wallets to store their NFTs. Highly valuable and sought after NFTs languish in the wallets only compatible with the chains on which they are minted. Some wallets (e.g., Yoroi®) do not even allow a user to display the NFTs in the user's wallet.

NFTs often have metadata associated with them, such as purchase price, currency, access rights, transferability rights, utility and other such metadata. It can be hard to keep track of and make meaningful use of such metadata since it is often scattered across different wallets on different blockchains.

NFTs often include rights to participate in air drops of further NFTs, and the result can be a proliferation of NFTs that are hard for users to organize, value or display. Additionally, users might not get the benefit of such participation rights since it can be hard to track and exercise these rights when NFTs are not organized or centralized.

NFTs are purchased in a variety of different currencies, and due to the fluctuation in values of those currencies, it can be very hard to track how much is invested in NFTs.

NFTs have a variety of utilities, but because users have so many NFTs scattered across different wallets, they might be missing opportunities to capitalize on the benefits of owning NFTs.

It is expensive and inconvenient to transfer NFTs among wallets, and no one wallet can store NFTs minted on different chains.

Existing use cases for NFTs include art, sports videos, and gaming, but there is not a good ordinary use case for users wanting to mint their own memorabilia. It would be desirable to make it easy for users to mint, share and display mementos from having visited famous landmarks, attending parties, attending weddings, starting a new job or departing a job, birth of a child, or any other major life occasion, event or trip that could be commemorated with an NFT.

It can be expensive to mint NFTs because of gas fees on the blockchain. Some blockchains are more expensive than others. Some blockchains are more widely accessible than others. The buyer or recipient of an NFT might want to choose the blockchain on which to mint their NFT. A capability to allow the buyer to mint on demand on a blockchain of their choice would avoid the cost of a seller maintaining expensive NFT inventory or choosing the blockchain before there is a buyer for the NFT.

Thus, there is a need for solutions that address these deficiencies in existing systems.

### SUMMARY OF THE INVENTION

An apparatus has a processor and a network interface circuit connected to the processor to provide connectivity to networked machines. A memory is connected to the processor. The memory stores instructions executed by the processor to establish a first network connection to a first proprietary block chain to obtain first non-fungible token (NFT) attributes associated with a first public key. A second network connection is created to a second proprietary block chain to obtain second NFT attributes associated with a second public key. A third network connection with a client machine supplies the first NFT attributes and the second NFT attributes to the client machine.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates cross-chain display operations performed in accordance with an embodiment of the invention.

FIG. 3 illustrates operations for on-demand minting on a selected proprietary block chain.

Like reference numerals refer to corresponding parts throughout the several views of the drawings.

### DETAILED DESCRIPTION

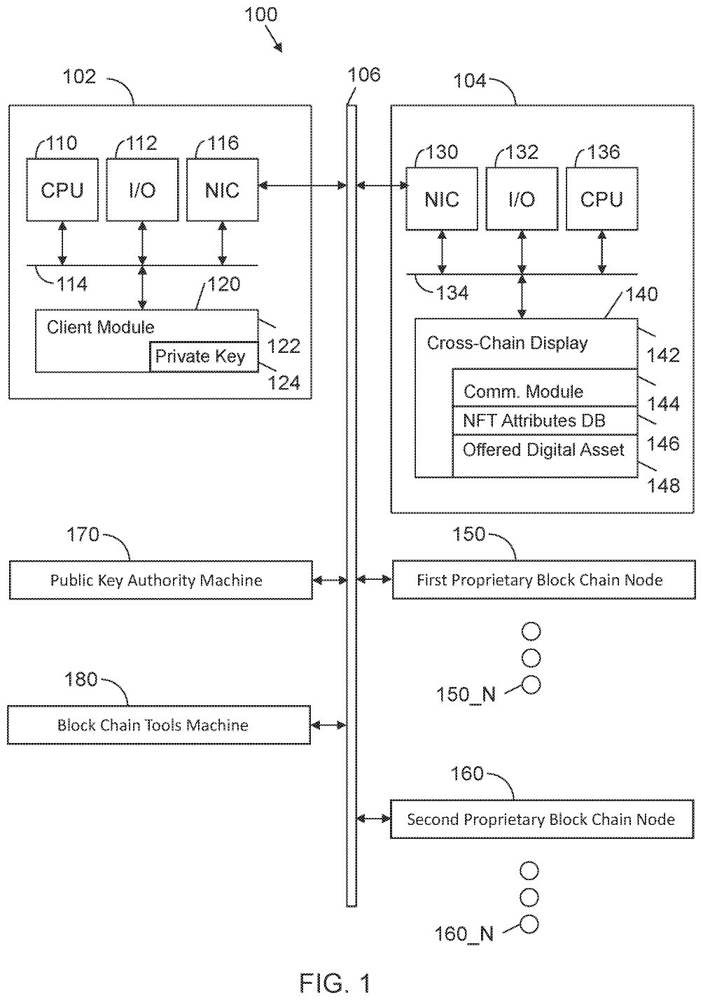

FIG. 1 illustrates a system 100 configured in accordance with an embodiment of the invention. A client machine 102 is connected to a server 104 via a network 106, which may be any combination of wired and wireless networks.

Client machine 102 includes a processor 102 (e.g., central processing unit or CPU) in communication with input/output devices 112 via a bus 114. The input/output device may include a keyboard, mouse, touch display and the like. A network interface circuit 116 is also connected to bus 114 to provide connectivity to network 106. A memory 120 is also connected to the bus 114. The memory 120 stores instructions executed by processor 102. The memory 120 includes a client module 122 that manages communications with devices on network 106. The client module 122 also stores a cryptographic private key 124 associated with a user of the client machine 102. The client machine 102 may be a personal computer, a laptop computer, smartphone and the like.

Server 104 includes a network interface circuit 130, input/output devices 132, a bus 134 and a processor 136. A memory 140 is connected to bus 134. The memory 140 stores a cross-chain display module 142 which includes instructions executed by processor 136 to implement operations disclosed herein. The cross-chain display module 142 includes a communications module 144 to coordinate communications with devices connected to network 106, as disclosed herein. The cross-chain display module 142 also stores NFT attributes in an NFT attributes database 146. The NFT attributes include digital representations of minted NFTs recorded on different proprietary block chains. The NFT attributes also include metadata associated with the different NFTs. Thus, the cross-chain display module 142 represents a single repository for NFTs minted on different platforms. Consequently, a user has a single repository for a variety of NFTs and their associated metadata.

An embodiment of the cross-chain display module 142 also includes an offered digital asset 148, which is a digital asset that is available for minting on a buyer's proprietary block chain of choice, as discussed below.

FIG. 1 also illustrates that system 100 includes a first proprietary block chain implemented with first proprietary block chain nodes 150 through 150_N. Each block chain node has components such as shown in server 104, but with a memory that stores instructions executed by a processor to implement block chain operations. Also connected to network 106 is a second proprietary block chain implemented with second proprietary block chain nodes 160 through 160_N. The second proprietary block chain nodes are also implemented as servers, such as server 104.

The system 100 may also include a public key authority machine 170 connected to network 106. The public key authority machine 170 may be a server configured to implement public key cryptography operations. Finally, the network 106 may include connections to one or more block chain tools machines 180. A block chain tools machine 180 is configured as a server that implements block chain tools, such as blockchain explorers, as discussed below.

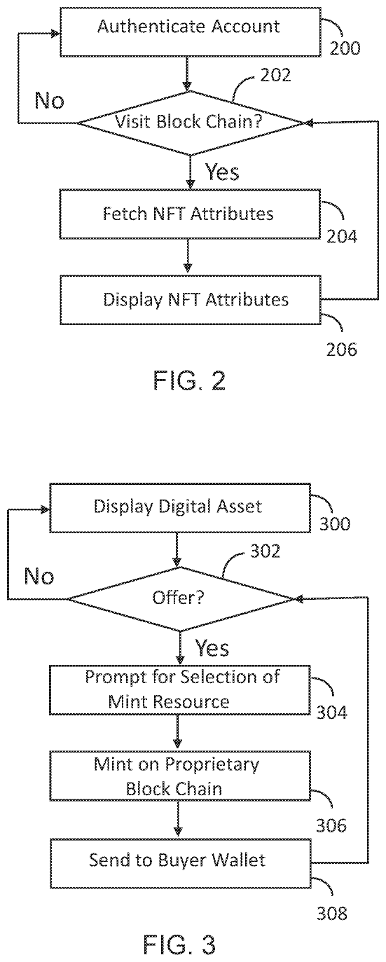

FIG. 2 illustrates processing operations performed by the cross-chain display module 142. An account is authenticated 200. For example, client module 102 communicates with communication module 144 via network 106 and supplies a user name and password, which are the only credentials that will be subsequently needed for a user to access cross-chain NFT attributes. The cross-chain display module 142 then prompts the user to visit a block chain to secure NFT attributes 202. If the user accepts the prompts, the communication module 144 uses a public key and a specified proprietary block chain to fetch NFT attributes 204. The NFT attributes can then be displayed 206 and control returns to block 202. The NFT attributes 206 may be sent to client device 102 for display on an output device, such as a display.

FIG. 3 illustrates operations associated with an offered digital asset 148. A digital asset is displayed 300. For example, server 104 makes it available for display to machines on network 106. If an offer is received (302—Yes), a user is prompted for selection of a mint resource 304. The digital asset is then minted on a proprietary block chain 306. The minted NFT is then sent to the buyer's wallet 308 and control returns to block 302. In this way, a user can offer a digital asset and only incur the expense of minting after the purchaser has agreed to a price and has specified a proprietary block chain. The minted NFT is sent to the buyer at the public address of a wallet associated with the proprietary blockchain. Minting on demand into a blockchain of choice allows a user to have wallets on different proprietary blockchains.

Those skilled in the art recognize that conventional crypto wallets support only a limited set of the large and growing number of blockchains and carry inherent security risks as the custodians of such assets. The proliferation of different blockchains and wallets and the popularity of NFTs has created a need for a system to index and track NFT assets across chains and wallets, without the security risks, gas fees or technological limitations that prevent centralization in a single wallet. The disclosed system provides a solution to these problems.

Furthermore, sellers of NFTs might prefer to allow buyers to choose the blockchain on which they mint an NFT, since the chosen blockchain has implications for the cost of minting and the wallet options where the NFT can be stored. The disclosed solution allows a buyer to mint a chosen NFT on demand, on a chosen blockchain, and into an associated compatible wallet.

The disclosed solution satisfies the need for a system that allows indexing of NFTs from many different blockchains and wallets in a single repository associated with a single user account. The number of different blockchains and wallets is already large and continues increasing. A typical NFT enthusiast using currently available technology would require at least three different wallets to hold NFTs on the commonly used blockchains that support the creation of NFTs, namely Ethereum® ERC-1155 standard, Flow®, WAX® chains, and likely would have many more since many other chains also support NFTs (e.g., Tezos®, Binance® Smart Chain, Cardano®). It is increasingly difficult to keep track of one's NFT assets, and it creates security risks to hold all of one's valuable NFTs in only a few wallets. The disclosed technology resolves these risks.

The disclosed invention solves prior art problems by offering a system for indexing of NFTs held across two or more wallets and two more blockchains. The claimed invention is directed to a lightweight system that tracks NFT assets from two or more wallets and allows them to be displayed, shared, and valued, without the blockchain specific limitations or security risks of wallets. This is done by allowing users to create an account, with typical login credentials, and then to associate wallets with the account by providing only the public address of the wallet, not the private key. The cross-chain display module 142 then indexes those wallets and creates a repository of NFT attributes held in those wallets, and further allows the user to associate metadata with NFT attributes. This is all done without transferring the NFTs; hence reference is made to NFT attributes to distinguish them from the actual NFTs, which remain registered on their proprietary block chains and stored in disparate wallets.

The cross-chain virtual display or “trophy case” drives more mainstream adoption of NFTs and can be coupled with an easy mint feature to allow laypeople to mint NFTs as personal mementos to share with friends (like a party or wedding favor). Because the system stores public addresses of a variety of wallets on behalf of an account holder, it can also allow the account holder to select assets for minting on demand and transfer minted assets to compatible wallets.

The disclosed system allows users to mint and share NFTs of occasions, events, trips, sites or places visited as memorability of everyday life events such as weddings, child births, special occasions, new jobs, party favors, and other such memorabilia worthy of commemoration.

A blockchain is a decentralized and distributed digital ledger that is used to record transactions across multiple computers. It is essentially a chain of blocks that contain information about transactions, with each block containing a list of records, or transactions. Once a block is added to the chain, the data in that block cannot be altered or deleted, ensuring the integrity and immutability of the data.

A crypto wallet is a digital wallet that stores a person's cryptocurrency holdings. Crypto wallets typically only support one or two specific blockchains because each blockchain has its own unique set of rules, protocols and infrastructure. Creating a wallet that supports multiple blockchains requires a significant amount of development and maintenance work to ensure that the wallet can properly interact with each blockchain's network. The functionality and features of different blockchains can vary greatly, making it difficult to design a single wallet that can effectively support all of them. For example, a wallet for a blockchain with smart contract functionality would need to have different features than a wallet for a blockchain that focuses on privacy. Another reason is that the way of storing data, signing transactions and other processes are different for different blockchains which make it difficult for a wallet to support more than one or two blockchains.

Each crypto wallet has an associated private key and public key. The private key is used to control assets in the wallet, whereas the public key is used to view or receive assets into the wallet. The private key must be kept secret because anyone possessing it can control and transfer the wallet's contents. The public key is, as its name suggests, intended to be public and is used to receive assets into the wallet. It is effectively the address of the wallet.

An NFT is a digital file depicting a creative work such as a photograph, drawing, written work in the form of a text file, video and/or audio recording that has been stored on a blockchain such as Ethereum®. An NFT can serve as proof of ownership of the contents of the digital file, as well as a record of provenance and authenticity. An NFT serves as a unique token that facilitates collection and exchange of digital assets.

Minting an NFT refers to the process of recording an entry on the blockchain pertaining to a digital file, and once recorded, the entry becomes immutable, and impossible to edit, modify or delete.

Accessing a wallet to control or transfer its contents requires the private key. The disclosed system does not use private keys and therefore does not put the user's assets at risk. Even though you can view the NFTs stored in a wallet using the public address, it is not possible to transfer or interact with the NFTs without the private key associated with the wallet; therefore, the assets are not at risk since the system does not use the private key.

The disclosed system allows users to “connect” (i.e., associate without a private key) two or more wallets from two or more different blockchains to an account, and then indexes the contents of those wallets and allows the user to view, display, and share the NFTs assets associated with those wallets. Since the NFTs are maintained in separate wallets, there is no added security risk from connecting and displaying them on a centralized platform. There is also no transfer costs or gas fees since the NFTs are not being moved from their wallets.

Wallet connections can be accomplished using only the public address of the chosen wallets, and not the private key(s). It is possible to determine the contents of a wallet using only the public address of the wallet using existing technology provided by publicly available blockchain explorers. A blockchain explorer is a website or tool that allows users to view information on the blockchain, including the transactions and balances associated with a specific address. By using the public address of a wallet, a blockchain explorer can view all the transactions associated with that address. If the transaction is an NFT transfer then one can extract the token identification and use that to view the metadata of the NFT on the smart contract or on the NFT marketplaces.

To use a blockchain explorer, simply input the public address of the wallet, and the explorer will return information about what is stored in the wallet. For example, the communication module 144 can communicate with the block chain tools machine 180 via network 106 to obtain NFT attributes from the first proprietary block chain nodes 150 through 150_N and the second proprietary block chain nodes 160 through 160_N.

One example of such a blockchain explorer is Blockchair®. Blockchair® is a blockchain explorer that supports multiple blockchain networks, including Ethereum®, and can show NFTs associated with a specific public wallet address. In Blockchair®, one can filter the blockchain transactions associated with a wallet address by type, and if the transaction is an NFT transfer, the transaction is labeled as “token transfer” and one can click on the transaction to view the details of the NFT, such as the token identification, symbol, and name. Other examples of blockchain explorers include: OpenSea®, a large marketplace for NFTs; NonFungible®, a blockchain explorer specifically designed for NFTs that includes information on token holders and transfer history; Rarible®, a marketplace and explorer for NFTs; EnjinX®, a fast and user-friendly blockchain explorer for Ethereum® and ERC-1155 tokens that allows searching and viewing of information on NFTs, addresses, and transactions; and, SuperRare®, a marketplace and explorer for NFTs that includes information on artists and prices of NFTs.

The cross-chain display module 142 compiles and provides account holders with an index of the contents of two or more wallets using the public address of the wallets, and by querying the associated blockchains, either directly or through publicly available blockchain explorers that can scan and compile the contents of wallets based on the public address of the wallet. To avoid the need to constantly reference blockchain explorers, the system can maintain, and periodically update, a database storing the contents of wallets by public address, as well as any metadata related to NFTs obtained from the blockchain or added through a user interface to the system by the account holder or other users of the system. That is, NFT attributes DB146 stores public addresses, digital files and associated metadata obtained from block chains and/or added by users. Different blockchain explorers provide different kinds of NFT attributes and/or metadata, including price, transaction history, provenance, royalty terms, etc. so it might be desirable to query multiple explorers to compile metadata for a given NFT. Users could also add metadata and associate it with NFTs on the platform by inputting information such as name, nickname, price, comments, likes, views, and other information. Imaging processing APIs also exist to allow the system to resize and reformat NFTs for more uniform display, particularly on mobile devices.

It should be noted that the system cannot guarantee that an account holder is the owner he or she chooses to associate with an account, but rather this allows an account holder to track wallets of their choice, whether or not they own them. However, if desired, the system could further allow users to “claim” one or more wallets associated with an account by establishing ownership using the private key, or some other proof of ownership, such as know your customer identification or proof of purchase. For example, to prove ownership of a wallet using a private key, the account holder would need to sign a message such as “I own this wallet” using the private key to encrypt the message and create a digital signature, share the message with the system, and the system could then verify the signature using the corresponding public key.

The system allows users to associate NFTs held in two or more wallets with an account and interact with those NFTs with activities such as choosing to hide or display publicly or selectively, filter, sort, tag, comment on, share, alter, create derivative works, add stickers, like, follow, value, receive notifications regarding, use as a profile picture, nickname and otherwise manipulate NFTs and their associated wallets. All of this can be done using a backend database that associates indexed NFTs and wallets with metadata input by the account owner or other users of the system.

Since the contents of custodial wallets can change and NFTs can be added or removed, the system can periodically query the blockchains, or associated APIs, for any updates. The frequency of updating the system can be adapted depending on the costs of querying the blockchains, and the needs of users. Power users for example, could pay for more frequent updates.

Because the system has an account holder's wallet addresses in order to index their chosen wallets, the system can also permit on-demand minting of new NFTs into a selected wallet. Minting NFTs is expensive so it is desirable for a seller to avoid minting an NFT until a buyer wants to purchase it. A buyer might also prefer to choose the blockchain on which it registers the NFT it is purchasing. In this way, a buyer with an account associated with several wallets across several blockchains, can select a digital image for purchase and choose the blockchain on which to mint it, and the system can then perform the steps of recording the NFT on the chosen blockchain and sending the resulting NFT to the buyer's selected wallet.

The process for minting an NFT on the blockchain involves creating a smart contract that defines the properties and functionality, deploying the smart contract on the blockchain using a tool such as Truffle® or Remix®, minting the NFT by calling the smart contract's mint function to create a new NFT and assign it a unique token ID, add the metadata associated with the NFT such as name, author, value, description, and finally, transfer the NFT to the buyer's wallet using the public address of the wallet by calling the smart contract's transfer function.

It's important to note that minting and registering an NFT on a blockchain such as the Ethereum® blockchain requires a small amount of Ether (ETH) as gas fees to pay for the computational power used by the nodes to validate the transaction and register it in the blockchain. Also, the receiving wallet must be compatible with the blockchain on which the NFT has been minted.

An embodiment of the present invention relates to a computer storage product with a computer readable storage medium having computer code thereon for performing various computer-implemented operations. The computer storage product can be any of a desktop, laptop, tablet, phone, watch or other hardware device. The media and computer code may be those specially designed and constructed for the purposes of the present invention, or they may be of the kind well known and available to those having skill in the computer software arts. Examples of computer-readable media include but are not limited to: magnetic media such as hard disks, solid state disks, magnetic tape, optical media, magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using an object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
a processor;
a network interface circuit connected to the processor to provide connectivity to networked machines; and
a memory connected to the processor, the memory storing instructions executed by the processor to:
establish a first network connection to a first proprietary block chain to obtain first non-fungible token (NFT) attributes associated with a first public key,
create a second network connection to a second proprietary block chain to obtain second NFT attributes associated with a second public key, and
hosting a third network connection with a client machine to supply the first NFT attributes and the second NFT attributes.

2. The apparatus of claim 1 wherein the first NFT attributes and the second NFT attributes include digital replications of the NFTs associated with the first public key and the second public key.

3. The apparatus of claim 1 wherein the first NFT attributes and the second NFT attributes include metadata characterizing the NFTs associated with the first public key and the second public key.

4. The apparatus of claim 1 wherein the first NFT attributes and the second NFT attributes are obtained using a blockchain explorer tool.

5. The apparatus of claim 1 further comprising instructions executed by the processor to:
display a digital asset to the networked machines;
receive an offer to purchase the digital asset from a buyer operating a buyer machine;
prompt the buyer machine for a selection of a mint resource from a group of proprietary block chain mint resources; and
utilize the selection to coordinate the minting of the digital asset on a network connected proprietary block chain to form a minted digital asset.

6. The apparatus of claim 5 further comprising instructions executed by the processor to transfer the minted digital asset to a wallet associated with a public key.

7. An apparatus, comprising:
a processor;
a network interface circuit connected to the processor to provide connectivity to networked machines; and
a memory connected to the processor, the memory storing instructions executed by the processor to:
establish a first network connection to a client machine;
display one or more digital assets to the client machine;
receive an offer to purchase a digital asset from the client machine, the offer specifying a selection of a digital asset and a public wallet address compatible with a blockchain,
coordinate the minting of the digital asset on the blockchain to form a minted asset,
transfer the minted asset to the public wallet address.

8. An apparatus, comprising:
a processor;
a network interface circuit connected to the processor to provide connectivity to networked machines; and
a memory connected to the processor, the memory storing instructions executed by the processor to:
establish a first network connection to a client machine;
receive from the client machine two or more public wallet addresses compatible with two or more blockchains;
display one or more digital assets to the client machine;
receive an offer to purchase a digital asset from the client machine, the offer specifying a selection of a digital asset and a selection of a blockchain,
coordinate the minting of the digital asset on the blockchain to form a minted asset,
transfer the minted asset to a public wallet address compatible with the selected blockchain.
